(19) United States
(12) Patent Application Publication
(10) Pub. No.: US 2024/0091980 A1
(43) Pub. Date: Mar. 21, 2024

(54) FLAME RETARDANT WOOD, PREPARATION METHOD THEREOF AND USE OF METAL HALIDE

(71) Applicant: NORTHEAST FORESTRY UNIVERSITY, HARBIN (CN)

(72) Inventors: WENSHUAI CHEN, HARBIN (CN); SHENGJIE LING, HARBIN (CN); SEN GAO, HARBIN (CN); QING LI, HARBIN (CN); JING REN, HARBIN (CN)

(73) Assignee: NORTHEAST FORESTRY UNIVERSITY, HARBIN (CN)

(21) Appl. No.: 18/206,897

(22) Filed: Jun. 7, 2023

Related U.S. Application Data
(63) Continuation of application No. PCT/CN2022/095435, filed on May 27, 2022.

(30) Foreign Application Priority Data
Jan. 10, 2022 (CN) 2022100200727

(51) Int. Cl. B27K 3/02; B27K 3/20; B27K 3/52

(52) U.S. Cl. CPC B27K 3/0214; B27K 3/20; B27K 3/52; B27K 2240/30

(57) ABSTRACT

The present disclosure provides a fire retardant wood, a preparation method thereof, and a use of metal halide. The preparation method of fire retardant wood includes: impregnating a wood with a salt solution. By injecting low-cost metal halide into the interior of wood, the present disclosure obtains wood with natural color and texture and high flame retardant ability, which is very suitable for use in decorative environment and is expected to be applied in many fields such as furniture, architecture, shipbuilding and ancient wood preservation.

### CROSS-REFERENCE TO RELATED APPLICATIONS

This is a continuation application claiming priority to a pending PCT application PCT/CN2022/095435, filed on May 27, 2022, which claims the priority to a Chinese application No. CN 202210020072.7, filed on Jan. 10, 2022, both of which are hereby incorporated by reference in their entireties, including any appendices or attachments thereof, for all purpose.

### TECHNICAL FIELD

The present disclosure relates to the technical field of flame retardant wood, in particular to a flame retardant wood, a preparation method thereof, and a use of metal halide.

### BACKGROUND OF THE INVENTION

As a natural and renewable material, wood is favored by people because of its beautiful color, luster and texture. However, due to its high flammability, it poses a huge threat to the safety of people's lives and property.

At present, there are many problems in fire retardant treatment of wood. First, fire retardant is expensive and complex to use when performing a fire retardant treatment process of wood, which is difficult to apply in a large scale. Second, the effect of a flame retardant is not ideal for not capable of preventing the spread of flame. Third, the addition of a flame retardant seriously affects the visual and tactile properties of natural wood, and limits the application of wood as a decorative material.

### SUMMARY OF THE INVENTION

The present disclosure provides a flame retardant wood and a preparation method thereof, and a use of metal halide.

The present disclosure is obtained through the following technical solutions.

The present disclosure provides a preparation method of fire retardant wood, including: impregnating a wood with a salt solution.

The preparation method further includes a drying process.

Preferably, the concentration of the salt solution is 1 wt %-50 wt %. A solvent in the salt solution of the present disclosure is water.

Preferably, a salt in the salt solution is metal halide.

More preferably, the metal halide is one or more selected from calcium halide, zinc halide, lithium halide, magnesium halide and sodium halide. More preferably, the metal halide is one or more selected from calcium chloride, lithium chloride, magnesium chloride, zinc chloride, calcium bromide, zinc bromide, sodium iodide and lithium iodide. Most preferably, the metal halide is selected from calcium chloride, lithium chloride and magnesium chloride.

Preferably, the impregnation is carried out under a vacuum condition, and the time of holding the vacuum condition is 1 h-20 h. The wood with smaller size and thinner thickness needs a shorter time of impregnating, and wood with larger size and thicker thickness needs a longer time. More preferably, a vacuum treatment under the vacuum condition is carried out for several times, and an atmospheric pressure condition is set at a period between two adjacent vacuum treatments. The time of treating under the atmospheric pressure is 1-5 min. A short time of treating under the atmospheric pressure is helpful to the impregnation. The vacuum treatment with multiple intervals is conducive to the better filling of metal halide aqueous solution into the wood.

More preferably, the number of times of the vacuum treatment is 1-50 times.

Preferably, the wood is made of broad-leaved trees, which is suitable for building engineering or furniture decoration. The wood of broad-leaved trees includes poplar and tung wood.

Preferably, the drying process is carried out under normal temperature and pressure. Preferably, the temperature is 20-30° C.

The present disclosure further provides a fire retardant wood, which is obtained by the preparation method as described above.

The present disclosure further provides a use of metal halide as a fire retardant for treating wood to form a fire retardant wood.

Preferably, the metal halide is one or more selected from calcium halide, zinc halide, magnesium halide, lithium halide and sodium halide. More preferably, the metal halide is one or more selected from calcium chloride, lithium chloride, magnesium chloride, zinc chloride, calcium bromide, zinc bromide, sodium iodide and lithium iodide. Most preferably, the metal halide is selected from calcium chloride, lithium chloride and magnesium chloride.

The beneficial effects of the above technical solutions of the present disclosure include:

1) The raw material of the preparation method provided in the present disclosure are cheap and easy to obtain, the preparation method is simple and convenient to operate, which is suitable for mass production.

2) The preparation method of the present disclosure has little influence on the color and texture of the wood after treatment.

3) The flame retardant wood obtained by the preparation method of the present disclosure has an extremely strong flame retardant effect. The limiting oxygen index of a FR-wood (Example 1) can reach 100%, the peak values of heat release rate and smoke release rate are reduced by 80% and 93%, respectively.

4) The preparation method of the present disclosure can realize a large-scale production of fire retardant wood.

In conclusion, by injecting low-cost metal halide into the interior of wood, the present disclosure obtains wood with natural color and texture and high flame retardant ability, which is very suitable for use in decorative environment and is expected to be applied in many fields such as furniture, architecture, shipbuilding and ancient wood preservation.

### BRIEF DESCRIPTION OF THE DRAWINGS

FIG. 1 is an appearance photo of an FR-wood obtained from Example 1.

FIG. 2 is a diagram showing the flame retardant effect of an FR-wood obtained from Example 1.

FIG. 3 is a diagram showing the fire retardant effect of wood treated with different metal halides compared with natural wood.

FIG. 4 shows the flame retardant mechanism of an FR-wood obtained from Example 1.

FIG. 5 shows the result of a three-point bending test of an FR-wood obtained from Example 1 and an R-wood that is not treated by Example 1.

FIG. 6 shows the result of a compression test of an FR-wood obtained from Example 1 and an R-wood that is not treated by Example 1.

FIG. 7 shows the result of a tensile test of an FR-wood obtained from Example 1 and an R-wood that is not treated by Example 1.

FIG. 8 shows the peak value of heat release rate of a flame retardant wood obtained from Examples 1-3 under the condition of 25.4° C. and 13.2RH %.

FIG. 9 shows the total amount of heat release of a flame retardant wood obtained from Examples 1-3 under the condition of 25.4° C. and 13.2RH %.

FIG. 10 shows the peak value of smoke release of a flame retardant wood obtained from Examples 1-3 under the condition of 25.4° C. and 13.2RH %.

FIG. 11 shows the total amount of smoke release of a flame retardant wood obtained from Examples 1-3 at 25.4° C. and 13.2RH %.

### DETAILED DESCRIPTION

The following specific embodiments illustrate the implementation of the present disclosure. Those skilled in the art can easily understand the other advantages and effects of the present disclosure from the content disclosed in this specification.

Before further describing the specific embodiments of the disclosure, it should be understood that the protection scope of the disclosure is not limited to the following specific embodiments. It should also be understood that the terms used in the present disclosure are intended to describe the specific embodiments, not to limit the protection scope of the present disclosure. The test method without specific conditions indicated in the following embodiments is generally in accordance with the conventional conditions or the conditions recommended by each manufacturer.

When a numerical range is given in the embodiment, it should be understood that, unless otherwise stated in the present disclosure, the two endpoints of each numerical range and any value between the two endpoints can be selected to implement the present disclosure. Unless otherwise defined, all technical and scientific terms used in the present disclosure have the same meaning as those commonly understood by those skilled in the art. In addition to the specific methods, equipment and materials used in the embodiments, according to the mastery of the prior art by those skilled in the art and the records of the present disclosure, the present disclosure can also be realized by using any methods, equipment and materials of the prior art that are similar or equivalent to the methods, equipment and materials described in the embodiments of the present disclosure.

The applicant found that for decorative wood, if the wood is expected to have characteristics of beautiful, safe and practical, it is necessary to make the treated wood retain the visual and tactile characteristics of natural wood, and have a good flame retardant effect.

The fire retardant wood obtained by traditional methods cannot meet the use requirements for decoration. However, the applicant accidentally found that the fire retardant wood obtained by impregnating the wood with the aqueous solution of metal halides can have a good effect on flame retardancy, and will not affect the color and texture of natural wood. The fire retardant wood obtained by this treatment is very suitable for furniture decoration.

The wood used in the embodiments of the present disclosure is poplar.

### EXAMPLE 1

A preparation method of a fire retardant wood in this example is as follows:
a. Solution preparation: prepare a calcium chloride solution with 20 wt % calcium chloride and distilled water, stir the calcium chloride solution to make the solution colorless and transparent, and cool the solution in an ice bath until the temperature of the solution is up to room temperature.
b. Wood impregnation: completely impregnate the wood in the calcium chloride solution obtained in step a.
c. Vacuum treatment: put the solution impregnated with wood in step b into a vacuum box for vacuum pumping, release the vacuum once every period of 20 hours, allow the solution to fill the interior of wood. Repeat this process for 3 times.
d. Dry at room temperature: take out the solution impregnated with wood obtained in step c from the vacuum box, keep the solution impregnated with wood for more than 1 minute under normal pressure, take out the wood from the solution, and dry the wood for 2 hours under normal temperature and pressure.

The wood after the vacuum treatment in step c was treated by different drying methods. The drying methods include a first drying method by which wood was dried under a normal pressure drying at a normal temperature, a second drying method by which wood was dried under a normal pressure at 60° C., and a third drying method by which wood was dried under a normal pressure drying at 100° C. The normal pressure represents the atmospheric pressure, and the normal temperature represents the room temperature, which may range from 20° C. to 30° C. After a drying treatment of the wood for 24 hours, a limiting oxygen index (LOI) of the wood was tested. The oxygen index of the wood using the first drying method is 100%, the oxygen index of the wood using the second drying method is 40.55%, and the oxygen index of the wood using the third drying method is 36.45%. It can be seen that different drying temperatures have different effects on the flame retardant performance of the wood, and the oxygen index of the wood treated at the normal temperature is the highest.

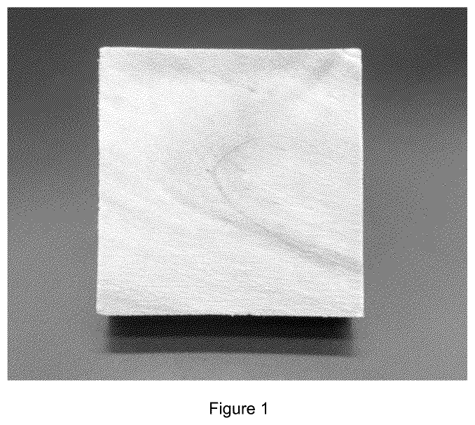

The flame retardant wood obtained in this embodiment is numbered as FR-wood, and its appearance photo is shown in FIG. 1. It can be seen from FIG. 1 that the color and texture of the wood have not changed at all, and the wood's natural color is still retained.

In order to test the effect of flame retardancy of the fire retardant wood, the following tests are carried out by the applicant.

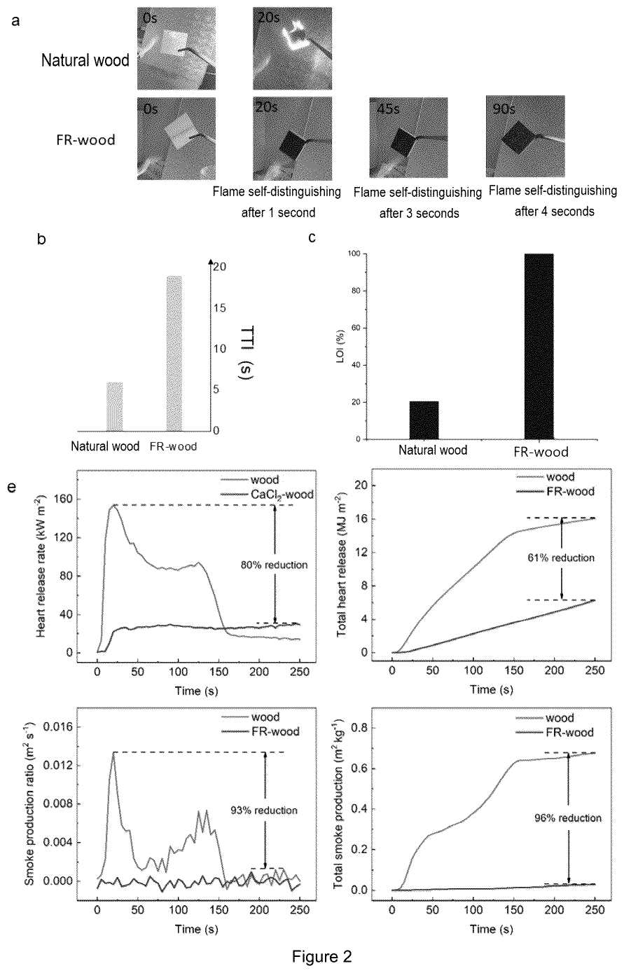

As shown in FIG. 2a, after being treated at a flame of 1300° C. for 20 s and leaving the flame, a combustion occurred on a large area of natural wood. On the contrary, for the FR-wood, after being treated at a flame of 1300° C. for 20 s and then leaving the flame, the flame is extinguished within 1 s and leaves a dense carbon layer on the surface of the FR-wood; after being treated at a flame of 1300° C. for 45 s and then leaving the flame, the flame is extinguished within 3 s and leaves a dense carbon layer on the surface of the FR-wood; after being treated at a flame of 1300° C. for 90 s and leaving the flame, the flame is extinguished within 4 s and leaves a dense carbon layer on the surface of the FR-wood.

As shown in FIG. 2b, according to the test method of ISO 5660-1 cone calorimeter, the time required to ignite a natural wood is 6 s, and the time required to ignite the FR-wood is 19 s, as shown in FIG. 2c. In addition, according to the test method of ISO 4589, the oxygen index of the FR-wood can reach 100% in a limiting oxygen index (LOI) test, while the oxygen index of the natural wood is only 20%. According to the test method of ISO 5660-1 cone calorimeter, the peak values of heat release rate and smoke release rate of the flame retardant wood prepared in this embodiment are reduced by 80% and 93%, respectively, and the total amount of heat release and smoke release is reduced by 61% and 96%, respectively, as shown in FIG. 2e.

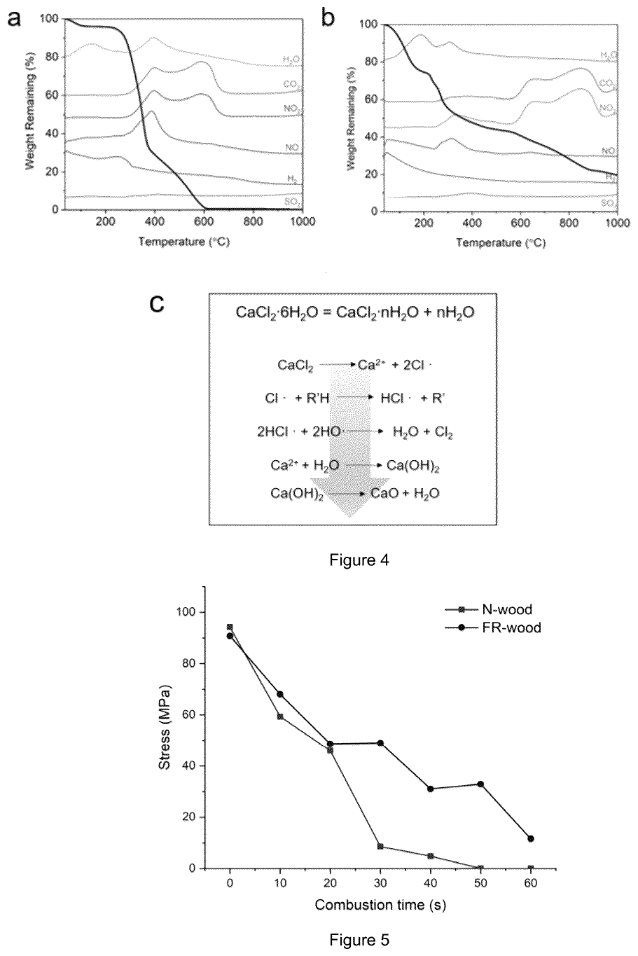

The flame retardant mechanism of FR-wood can be obtained through a TG-MS analysis. FIG. 4a is a TG-MS diagram of natural wood, FIG. 4b is a TG-MS diagram of FR-wood, the flame retardant mechanism includes:

1) Dehydration:

The dehydration of natural wood and FR-wood is divided into two stages, the first stage is the removal of free water, and the second stage is the removal of combined water. The highest temperature for removal of free water in natural wood is 143° C., and the highest temperature for removal of free water in FR-wood is 187° C., which indicates that compared with natural wood, the removal of free water in FR-wood is more difficult, the FR-wood has a better water retention. Besides, Water can be used as a typical flame retardant, indicating that the better the water retention is, the better the flame retardant effect will be. The second stage is the pyrolysis of wood components into charcoal. In the second stage, the highest temperature of pyrolysis of natural wood is 395° C., and that of FR-wood is 305° C., indicating that the pyrolysis temperature of wood components of FR-wood is reduced, because a dense carbon layer is formed in advance, which blocks a lot of heat from the outside and slows down the pyrolysis of wood components under the carbon layer.

2) Gas Phase Dilution:

The combustion of FR-wood will produce a large number of non-combustible gases such as H₂O, SO₂, CO₂, etc., the release of these gases will dilute the oxygen and gaseous combustibles in the surrounding environment. Meanwhile, the non-combustible gases also have a certain role in heat dissipation and cooling, thereby preventing the combustion.

3) Coagulation and Isolation:

CaCl₂) will produce a small amount of inorganic acid at a high temperature, which will dehydrate the wood. At the same time, under the catalysis of Ca 2+, a porous dense carbon layer can be formed by promoting a cross-linking of wood. The carbon layer can isolate air and heat conduction, prevent the volatilization of a combustible gas, protect the wood matrix, and achieve the purpose of flame retardant.

4) Radical Quenching:

Natural wood will produce a large number of combustible free radicals during combustion, the free radicals will react with a combustible gas to generate new combustible free radicals, providing fuel for the flame continuously, leading to a chain reaction, thus spreading the flame. FR-wood produces less reactive CI radicals during combustion and has the ability to capture combustible radicals, which in turn stops the chain reaction.

FIG. 5 shows the result of a three-point bending test of the FR-wood obtained from Example 1 and an R-wood that is not treated by Example 1. The size of samples to be tested for the three-point bending test is 10 cm (long)×1 cm (width)×0.8 cm (high). The test method for the three-point bending in the present disclosure is GB/T 9341-2008.

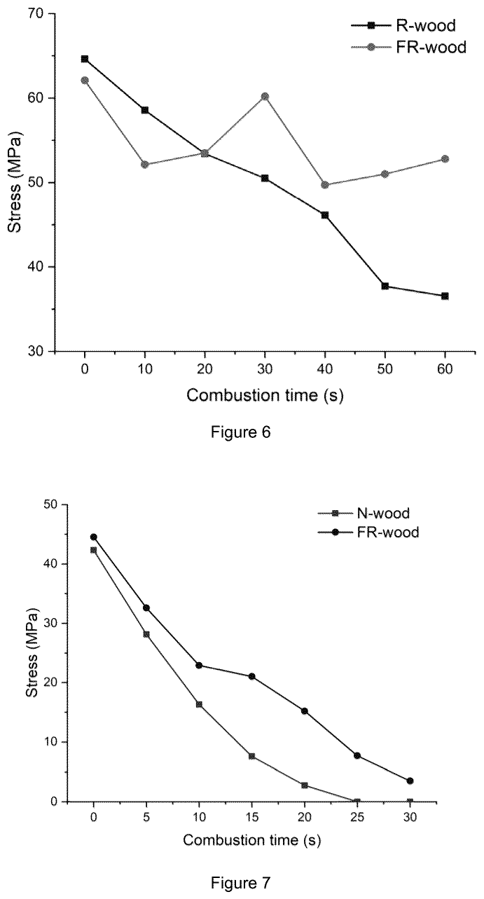

FIG. 6 shows the result of a compression test of the FR-wood obtained from Example 1 and an R-wood that is not treated by Example 1. The size of samples to be tested for the compression test is 4 cm (long)×2 cm (Width)×1 cm (high). The test method for the compression in the present disclosure is GB 13022-91.

FIG. 7 shows the result of a tensile test of the FR-wood obtained from Example 1 and an R-wood that is not treated by Example 1. The size of samples to be tested for the tensile test is 15 cm (long)×1 cm (Width)×0.4 cm (high). The test method for the tensile test in the present disclosure is GB/T1041-92.

It can be seen from FIG. 5, FIG. 6 and FIG. 7 that the mechanical properties of FR-wood are very similar to those of R-wood before combustion. As the combustion time becomes longer, the mechanical properties of R-wood decrease significantly, moreover, the R-wood cannot maintain its own form under a longer combustion time. However, the mechanical properties of FR-wood decreased relatively slowly during the combustion process, and the FR-wood shows relatively strong mechanical properties under flame treatment.

### EXAMPLE 2

A preparation method of a fire retardant wood in this example is as follows:
a. Solution preparation: prepare a calcium chloride solution with 30 wt % calcium chloride and distilled water, stir the calcium chloride solution to make the solution colorless and transparent, and cool the solution in an ice bath until the temperature of the solution is up to room temperature.

b. Wood impregnation: completely impregnate the wood in the calcium chloride solution obtained from step a to obtain the solution impregnated with wood.

c. Vacuum treatment: put the solution impregnated with wood in step b into a vacuum box for vacuum pumping, release the vacuum once every period of 20 hours, allow the solution to fill the interior of wood. Repeat this process for 2 times.

d. Dry at room temperature: take out the solution impregnated with wood obtained in step c from the vacuum box, keep the solution impregnated with wood for more than 1 minute under normal pressure, take out the wood from the solution, and dry the wood for 2 hours under normal temperature and pressure.

### EXAMPLE 3

A preparation method of a fire retardant wood in this example is as follows:
a. Solution preparation: prepare a calcium chloride solution with 10 wt % calcium chloride and distilled water, stir the calcium chloride solution to make the solution colorless and transparent, and cool the solution in an ice bath until the temperature of the solution is up to room temperature.
b. Wood impregnation: completely impregnate the wood in the calcium chloride solution obtained from step a to obtain the solution impregnated with wood.
c. Vacuum treatment: put the solution impregnated with wood in step b into a vacuum box for vacuum pumping, release the vacuum once every period of 5 hours, allow the solution to fill the interior of wood. Repeat this process for 10 times.
d. Dry at room temperature: take out the solution impregnated with wood obtained in step c from the vacuum box, keep the solution impregnated with wood for more than 1 minute under normal pressure, take out the wood from the solution, and dry the wood for 2 hours under normal temperature and pressure.

### EXAMPLE 4

A preparation method of a fire retardant wood in this example is as follows:
a. Solution preparation: prepare a calcium chloride solution with 5 wt % calcium chloride and distilled water, stir the calcium chloride solution to make the solution colorless and transparent, and cool the solution in an ice bath until the temperature of solution is up to room temperature.
b. Wood impregnation: completely impregnate the wood in the calcium chloride solution obtained from step a to obtain the solution impregnated with wood.
c. Vacuum treatment: put the solution impregnated with wood in step b into a vacuum box for vacuum pumping, release the vacuum once every period of 5 hours, allow the solution to fill the interior of wood. Repeat this process for 10 times.
d. Dry at room temperature: take out the solution impregnated with wood obtained in step c from the vacuum box, keep the solution impregnated with wood for more than 1 minute under normal pressure, take out the wood from the solution, and dry the wood for 2 hours under normal temperature and pressure.

### EXAMPLE 5

A preparation method of a fire retardant wood in this example is as follows:
a. Solution preparation: prepare a zinc chloride solution with 20 wt % zinc chloride and distilled water, stir the zinc chloride solution to make the solution colorless and transparent, and cool the solution in an ice bath until the temperature of the solution is up to room temperature.
b. Wood impregnation: completely impregnate the wood in the zinc chloride solution obtained from step a to obtain the solution impregnated with wood.
c. Vacuum treatment: put the solution impregnated with wood in step b into a vacuum box for vacuum pumping, release the vacuum once every period of 20 hours, allow the solution to fill the interior of wood. Repeat this process for 2 times.
d. Dry at room temperature: take out the solution impregnated with wood obtained in step c from the vacuum box, keep the solution impregnated with wood for more than 1 minute under normal pressure, take out the wood from the solution, and dry the wood for 2 hours under normal temperature and pressure.

### EXAMPLE 6

A preparation method of a fire retardant wood in this example is as follows:
a. Solution preparation: prepare a lithium chloride solution with 30 wt % lithium chloride and distilled water, stir the lithium chloride solution to make the solution colorless and transparent, and cool the solution in an ice bath until the temperature of the solution is up to room temperature.
b. Wood impregnation: completely impregnate the wood in the lithium chloride solution obtained from step a to obtain the solution impregnated with wood.
c. Vacuum treatment: put the solution impregnated with wood in step b into a vacuum box for vacuum pumping, release the vacuum once every period of 10 hours, allow the solution to fill the interior of wood. Repeat this process for 5 times.
d. Dry at room temperature: take out the solution impregnated with wood obtained in step c from the vacuum box, keep the solution impregnated with wood for more than 1 minute under normal pressure, take out the wood from the solution, and dry the wood for 2 hours under normal temperature and pressure.

### EXAMPLE 7

The difference between this example and Example 1 is that the metal halide used to prepare a solution in step a in this embodiment is calcium bromide, and other conditions and processes are the same as those of Example 1.

### EXAMPLE 8

The difference between this example and Example 1 is that the metal halide used to prepare a solution in step a in this embodiment is zinc bromide, and other conditions and processes are the same as those of Example 1.

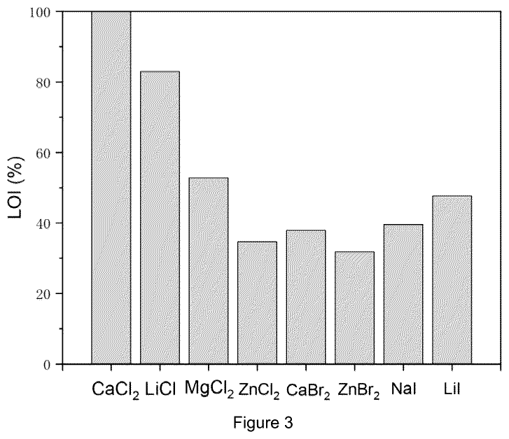

The oxygen indexes of fire retardant woods obtained from Examples 1-8 are shown in FIG. 3, the oxygen index is determined by an LOI test according to the method of ISO 4589.

In the present application, the preparation methods in Example 1-8 are all carried out under the conditions that the temperature is 25° C. and the humidity is 65%. The test results of fire retardant woods obtained from Examples 1-8 are shown in the following table, which includes: the percentage reduction of the peak value of heat release rate, the percentage reduction of the peak value of smoke release rate, the percentage reduction of the total amount of heat release and the percentage reduction of the total amount of smoke release.

In the present application, PHRR represents the peak value of heat release rate, i.e. the maximum value of HRR during combustion. The greater the value of PHRR, the greater the possibility of occurring fire. HRR represents the heat release rate, which refers to the amount of heat released by combustion in unit time under specified test conditions. The greater the HRR, the more heat the combustion feeds back to the surface of materials.

In the present application, THR represents the total amount of heat release.

In the present application, PSPR represents the peak value of heat release rate, i.e. the maximum value of SPR during combustion. SPR represents the smoke release rate, which refers to the amount of smoke produced by combustion in unit time under specified test conditions, and is used to evaluate the smoke release behavior of materials during combustion.

In the present application, TSP represents the total amount of smoke release.

| | | Percentage | Percentage | Percentage | Percentage |
|---|---|---|---|---|---|
| | | reduction of | reduction of | reduction of | reduction of |
| | Fire retardant wood | PHRR (%) | THR (%) | PSPR (%) | TSP (%) |
| Example | 20 wt % CaCl₂ | 80 | 61 | 93 | 96 |
| 1 | impregnation treatment | | | | |
| Example | 20 wt % ZnCl₂ | 94 | 96 | −60 | −320 |
| 5 | impregnation treatment | | | | |
| Example | 30 wt % LiCl | 83 | 97 | 79 | 68 |
| 6 | impregnation treatment | | | | |
| Example | 20 wt % CaBr₂ | 76 | 59 | 78 | 88 |
| 7 | impregnation treatment | | | | |
| Example | 20 wt % ZnBr₂ | 56 | 25 | 33 | 35 |
| 8 | impregnation treatment | | | | |

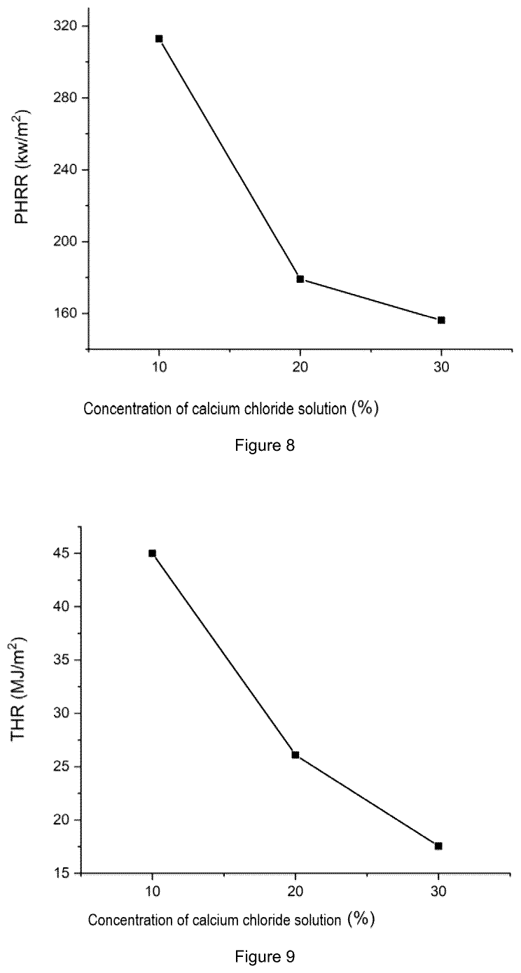

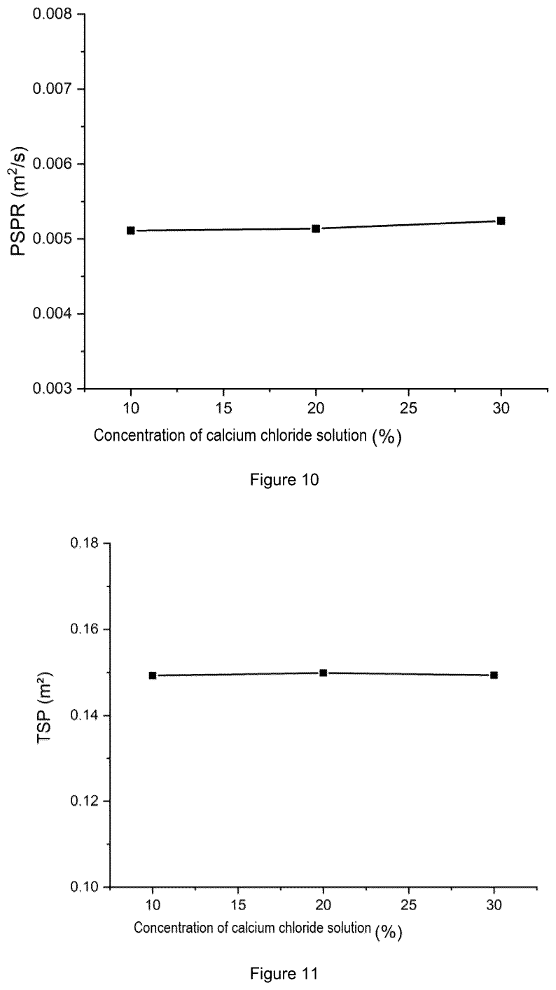

Under the conditions of 25.4° C. and 13.2RH %, the fire retardant woods are prepared according to Examples 1-3, and tested to determine the properties of the prepared fire retardant woods. The test results are shown in FIGS. 8-11. It can be seen from these FIGS. that with the increase of concentration of calcium chloride, the fire retardancy of wood is gradually improved, the ability of smoke suppression remains at a high level. When the concentration of calcium chloride reached 30 wt %, the color of wood surface changes significantly, being not conducive to decoration. In conclusion, a calcium chloride solution concentration of 20 wt % is selected as the optimal concentration for wood-treatment.

### EXAMPLE 9

A preparation method of a fire retardant wood in this example is as follows:
a. Solution preparation: prepare a calcium chloride solution with 20 wt % calcium chloride and distilled water, stir the calcium chloride solution to make the solution colorless and transparent, and cool the solution in an ice bath until the temperature of the solution is up to room temperature.
b. Wood impregnation: completely impregnate the wood in the calcium chloride solution obtained from step a to obtain the solution impregnated with wood.
c. Vacuum treatment: put the solution impregnated with wood in step b into a vacuum box for vacuum pumping, release the vacuum once every period of 5 hours, allow the solution to fill the interior of wood. Repeat this process for 10 times.
d. Dry at room temperature: take out the solution impregnated with wood obtained in step c from the vacuum box, keep the solution impregnated with wood for more than 1 minute under normal pressure, take out the wood from the solution, and dry the wood for 2 hours under normal temperature and pressure.

### EXAMPLE 10

A preparation method of a fire retardant wood in this example is as follows:
a. Solution preparation: prepare a magnesium chloride solution with 20 wt % magnesium chloride and distilled water, stir the magnesium chloride solution to make the solution colorless and transparent, and cool the solution in an ice bath until the temperature of the solution is up to room temperature.
b. Wood impregnation: completely impregnate the wood in the magnesium chloride solution obtained from step a to obtain the solution impregnated with wood.
c. Vacuum treatment: put the solution impregnated with wood in step b into a vacuum box for vacuum pumping, release the vacuum once every period of 5 hours, allow the solution to fill the interior of wood. Repeat this process for 10 times.
d. Dry at room temperature: take out the solution impregnated with wood obtained in step c from the vacuum box, keep the solution impregnated with wood for more than 1 minute under normal pressure, take out the wood from the solution, and dry the wood for 2 hours under normal temperature and pressure.

### EXAMPLE 11

A preparation method of a fire retardant wood in this example is as follows:
a. Solution preparation: prepare a lithium chloride solution with 20 wt % lithium chloride and distilled water, stir the lithium chloride solution to make the solution colorless and transparent, and cool the solution in an ice bath until the temperature of the solution is up to room temperature.
b. Wood impregnation: completely impregnate the wood in the lithium chloride solution obtained from step a to obtain the solution impregnated with wood.
c. Vacuum treatment: put the solution impregnated with wood in step b into a vacuum box for vacuum pumping, release the vacuum once every period of 5 hours, allow the solution to fill the interior of wood. Repeat this process for 10 times.
d. Dry at room temperature: take out the solution impregnated with wood obtained in step c from the vacuum box, keep the solution impregnated with wood for more than 1 minute under normal pressure, take out the wood from the solution, and dry the wood for 2 hours under normal temperature and pressure.

### EXAMPLE 12

A preparation method of a fire retardant wood in this example is as follows:
a. Solution preparation: prepare a zinc chloride solution with 20 wt % zinc chloride and distilled water, stir the zinc chloride solution to make the solution colorless and transparent, and cool the solution in an ice bath until the temperature of the solution is up to room temperature.
b. Wood impregnation: completely impregnate the wood in the zinc chloride solution obtained from step a to obtain the solution impregnated with wood.
c. Vacuum treatment: put the solution impregnated with wood in step b into a vacuum box for vacuum pumping, release the vacuum once every period of 5 hours, allow the solution to fill the interior of wood. Repeat this process for 10 times.
d. Dry at room temperature: take out the solution impregnated with wood obtained in step c from the vacuum box, keep the solution impregnated with wood for more than 1 minute under normal pressure, take out the wood from the solution, and dry the wood for 2 hours under normal temperature and pressure.

### EXAMPLE 13

A preparation method of a fire retardant wood in this example is as follows:
a. Solution preparation: prepare a calcium bromide solution with 20 wt % calcium bromide and distilled water, stir the calcium bromide solution to make the solution colorless and transparent, and cool the solution in an ice bath until the temperature of the solution is up to room temperature.
b. Wood impregnation: completely impregnate the wood in the calcium bromide solution obtained from step a to obtain the solution impregnated with wood.
c. Vacuum treatment: put the solution impregnated with wood in step b into a vacuum box for vacuum pumping, release the vacuum once every period of 5 hours, allow the solution to fill the interior of wood. Repeat this process for 10 times.
d. Dry at room temperature: take out the solution impregnated with wood obtained in step c from the vacuum box, keep the solution impregnated with wood for more than 1 minute under normal pressure, take out the wood from the solution, and dry the wood for 2 hours under normal temperature and pressure.

### EXAMPLE 14

A preparation method of a fire retardant wood in this example is as follows:
a. Solution preparation: prepare a zinc bromide solution with 20 wt % zinc bromide and distilled water, stir the zinc bromide solution to make the solution colorless and transparent, and cool the solution in an ice bath until the temperature of the solution is up to room temperature.
b. Wood impregnation: completely impregnate the wood in the zinc bromide solution obtained from step a to obtain the solution impregnated with wood.
c. Vacuum treatment: put the solution impregnated with wood in step b into a vacuum box for vacuum pumping, release the vacuum once every period of 5 hours, allow the solution to fill the interior of wood. Repeat this process for 10 times.
d. Dry at room temperature: take out the solution impregnated with wood obtained in step c from the vacuum box, keep the solution impregnated with wood for more than 1 minute under normal pressure, take out the wood from the solution, and dry the wood for 2 hours under normal temperature and pressure.

### EXAMPLE 15

A preparation method of a fire retardant wood in this example is as follows:
a. Solution preparation: prepare a sodium iodide solution with 20 wt % sodium iodide and distilled water, stir the sodium iodide solution to make the solution colorless and transparent, and cool the solution in an ice bath until the temperature of the solution is up to room temperature.
b. Wood impregnation: completely impregnate the wood in the sodium iodide solution obtained from step a to obtain the solution impregnated with wood.
c. Vacuum treatment: put the solution impregnated with wood in step b into a vacuum box for vacuum pumping, release the vacuum once every period of 5 hours, allow the solution to fill the interior of wood. Repeat this process for 10 times.
d. Dry at room temperature: take out the solution impregnated with wood obtained in step c from the vacuum box, keep the solution impregnated with wood for more than 1 minute under normal pressure, take out the wood from the solution, and dry the wood for 2 hours under normal temperature and pressure.

### EXAMPLE 16

A preparation method of a fire retardant wood in this example is as follows:
a. Solution preparation: prepare a lithium iodide solution with 20 wt % lithium iodide and distilled water, stir the lithium iodide solution to make the solution colorless and transparent, and cool the solution in an ice bath until the temperature of the solution is up to room temperature.
b. Wood impregnation: completely impregnate the wood in the lithium iodide solution obtained from step a to obtain the solution impregnated with wood.
c. Vacuum treatment: put the solution impregnated with wood in step b into a vacuum box for vacuum pumping, release the vacuum once every period of 5 hours, allow the solution to fill the interior of wood. Repeat this process for 10 times.
d. Dry at room temperature: take out the solution impregnated with wood obtained in step c from the vacuum box, keep the solution impregnated with wood more than 1 minute under normal pressure, take out the wood from the solution, and dry the wood for 2 hours under normal temperature and pressure.

| | | percentage | percentage | percentage | percentage |
|---|---|---|---|---|---|
| | | reduction of | reduction of | reduction of | reduction of |
| | Fire retardant wood | PHRR (%) | THR (%) | PSPR (%) | TSP (% ) |
| Example 9 | 20 wt % CaCl₂ | 80 | 61 | 93 | 96 |
| | impregnation treatment | | | | |
| Example | 20 wt % MgCl₂ | 78 | 74 | 83 | 94 |
| 10 | impregnation treatment | | | | |
| Example | 20 wt % LiCl | 83 | 97 | 79 | 68 |
| 11 | impregnation treatment | | | | |
| Example | 20 wt % ZnCl₂ | 94 | 96 | −60 | −320 |
| 12 | impregnation treatment | | | | |
| Example | 20 wt % CaBr₂ | 76 | 59 | 78 | 88 |
| 13 | impregnation treatment | | | | |
| Example | 20 wt % ZnBr₂ | 56 | 25 | 33 | 35 |
| 14 | impregnation treatment | | | | |
| Example | 20 wt % NaI | 48 | 79 | 60 | 32 |
| 15 | impregnation treatment | | | | |
| Example | 20 wt % LiI impregnation | 71 | 58 | 8 | 16 |
| 16 | treatment | | | | |

It can be seen from the above table that the wood treated with CaCl₂, MgCl₂, LiCl and CaBr₂ have an outstanding effect on flame retardancy and smoke suppression. However, for the wood treated with ZnBr₂, Nal and Lit, the ability of flame retardant is greatly improved, and the ability of smoke suppression is less improved. It should be noted that the ability of flame retardancy of wood treated with ZnCl₂ is improved, the ability of smoke suppression of it is deteriorated.

The above embodiments are only illustrative of the principle and efficacy of the present disclosure, and are not intended to limit the disclosure. Anyone familiar with this technology can modify or change the above-mentioned embodiments without violating the spirit and scope of the present disclosure. Therefore, all equivalent modifications or changes made by those with ordinary knowledge in the technical field without departing from the spirit and technical ideas disclosed by the present disclosure shall still be covered by the claims.

What is claimed is:

1. A preparation method of fire retardant wood, comprising: impregnating a wood with a salt solution.

2. The preparation method according to claim 1, further comprising a drying process.

3. The preparation method according to claim 2, wherein the drying process comprises: drying the wood under a normal pressure at a normal temperature.

4. The preparation method according to claim 3, wherein the wood is dried at a temperature ranging from 20° C. to 30° C.

5. The preparation method according to claim 1, wherein the concentration of the salt solution is 1 wt %-50 wt %.

6. The preparation method according to claim 1, wherein a salt in the salt solution is metal halide.

7. The preparation method according to claim 6, wherein the metal halide is one or more selected from calcium halide, zinc halide, lithium halide, magnesium halide and sodium halide.

8. The preparation method according to claim 6, wherein the metal halide is one or more selected from calcium chloride, lithium chloride, magnesium chloride, zinc chloride, calcium bromide, zinc bromide, sodium iodide and lithium iodide.

9. The preparation method according to claim 1, wherein the impregnating is carried out under a vacuum condition.

10. The preparation method according to claim 1, wherein the impregnating is carried out under a vacuum condition for 1 h-20 h, and/or, a vacuum treatment under the vacuum condition is carried out for a plurality of times, and an atmospheric pressure condition is set at a period between two adjacent vacuum treatments.

11. A fire retardant wood, prepared by the preparation method according to claim 1.

12. A use of metal halide in serving as a fire retardant for treating wood to form a fire retardant wood.

13. The use according to claim 12, wherein the metal halide is one or more selected from calcium halide, zinc halide, lithium halide, magnesium halide and sodium halide.
